(19) United States
(12) Patent Application Publication
(10) Pub. No.: US 2026/0269610 A1
(43) Pub. Date: Sep. 10, 2026

(54) SYSTEMS AND METHODS FOR DC POWER STATIONS AND GRIDS

(71) Applicant: Victor Shao, Mountain View, CA (US)

(72) Inventors: Victor SHAO, Mountain View, CA (US); Luke CLAUSE, Mountain View, CA (US); Louis ABASTAS, Mountain View, CA (US)

(21) Appl. No.: 19/559,582

(22) Filed: Mar. 6, 2026

Related U.S. Application Data
(60) Provisional application No. 63/768,530, filed on Mar. 7, 2025.

(51) Int. Cl. H02J 1/10; H02J 1/08

(52) U.S. Cl. CPC H02J 1/106; H02J 1/084

(57) ABSTRACT

A DC power management system can include an energy supply connected to a charging station using a DC bus and a controller in electrical communication with the energy supply and the charging station. Several DC power management systems can be connected using DC buses and can transfer power between DC power management systems as needed to manage supply and demand of DC voltage systems across a DC power grid.

### CROSS-REFERENCE TO RELATED APPLICATIONS

This claims the benefit of, and priority to, U.S. Provisional Patent Application No. 63/768,530, filed 7 Mar. 2025, entitled SYSTEMS AND METHODS FOR DC POWER STATIONS AND GRIDS, the entire disclosure of which is hereby incorporated by reference.

### FIELD

The described embodiments relate generally to electrical utility grids, networks, generators, power plants, and stations for providing power to electrical devices such as electric vehicles (EVs), and more specifically to modular, interconnected direct current (DC) charging stations and grids.

### BACKGROUND

Conventional power stations are connected utility grid services that provide alternating current (AC) power. Such conventional systems are inefficient and have difficulty providing adequate power as compared to direct current (DC) power systems. Demand for DC power systems has therefore risen with the rapid electrification of vehicles and other appliances, equipment, data centers, large-scale computing platforms, and/or machines that have run on fossil fuels in the past. Existing vehicle charging providers, for example, have connected charging station equipment such as charging stations, converters, and transformers to existing AC infrastructure to address this demand, but AC power transfer over long distances and AC to DC power conversion increases energy losses and makes such solutions undesirable. Additionally, fitting AC to DC converters at every power consumption site is costly. For these and other reasons, there is a constant need for DC power to be provided at sites with reduced losses, improved efficiency, and more convenience.

### SUMMARY

One aspect of the present disclosure relates to a direct current (DC) grid system that may comprise a DC energy or power source connected to a first station using a first DC bus, a DC energy or power load connected to a second station using a second DC bus, and a controller, wherein the controller may be in electrical communication with the first station and the second station, the DC energy or power source and the DC second energy or power load may be connected via an electrical connection between the first DC bus and the second DC bus, a first electrical characteristic may be measured at the DC energy or power source, a second electrical characteristic may be measured at the DC energy or power load, and the controller may be configured to control power transfer from the first station to the second station based on the first electrical characteristic, the second electrical characteristic, or both.

In some examples, the DC energy or power source may comprise a battery or a generator, and the DC energy or power load may comprise a charging station. In some examples, the DC energy or power source may output a DC voltage. In some examples, the first electrical characteristic and the second electrical characteristic may include at least one of an energy storage level, a power generation rate, or an electrical consumption rate. In some examples, the DC energy or power load may be configured as a charging station to charge electric vehicles, equipment, or machinery. In some examples, the controller may be a first controller and the system may further comprise a second controller in electrical communication with the first station and a third controller in electrical communication with the second station. In some examples, the second controller may be configured to control components at the second station in response to at least one signal from the first controller. In some examples, a plurality of stations may be connected via DC buses to create a DC power grid. In some examples, only DC energy or power sources may be connected to the first station. In some examples, only DC energy or power loads may be connected to the second station. In some examples, the DC energy or power load may be configured as a data center, supercomputer, or cluster computing facility.

Another aspect of the present disclosure relates to a DC grid station that may comprise a controller, at least one DC source with the at least one source including at least one energy source or at least one power source, a set of DC loads, and a DC bus connecting the at least one source to the set of DC loads, wherein the controller may be configured to detect power provided by the at least one source to the bus and consumption of the set of DC loads from the bus, and wherein, when the power provided by the source to the bus exceeds the consumption of the set of DC loads from the bus, the controller may be enabled to execute energy transfer to a second DC grid station via the bus.

For this aspect, in some examples, the controller may be enabled to execute energy transfer to a second bus of the second DC grid station, wherein the bus of the DC grid station may be in electrical communication with the second bus of the second DC grid station. In some examples, the set of DC loads may include a plurality of computer server racks. In some examples, the controller may be in electronic communication with a second controller of the second DC grid station, and the controller may receive a signal indicating an electrical characteristic of the second DC grid station.

Yet another aspect of the present disclosure is a computer-implemented method for controlling distribution of direct-current (DC) power between DC power stations that may comprise receiving, at a controller of a first station, an energy transfer request originating from a second station, sensing, by the controller, at least one electrical characteristic of the first station, and determining, by the controller, whether to accept the energy transfer request based on the at least one electrical characteristic, wherein, when the controller accepts the energy transfer, components of the second station may be controlled to transfer electrical power via an electrical connection between a first DC bus of the first station and a second DC bus of the second station, and wherein, when the controller does not accept the energy transfer, the controller may transmit a signal declining the energy transfer.

For this aspect, in some examples, the at least one electrical characteristic may comprise an available power value for the first station. In some examples, determining, by the controller, whether to accept the energy transfer request may comprise determining whether the available power indicates excess power at the first station. In some examples, the components of the second station may be controlled to transfer electrical power from the first station to the second station. In some examples, the components of the second station may be controlled to transfer electrical power from the second station to the first station.

In at least one example of the present disclosure a system can include a first energy supply connected to a first charging station using a DC bus, a second energy supply connected to a second charging station using a DC bus, and a controller, wherein the controller is in electrical communication with the first supply, the second supply, the first charging station, and the second charging station, the first energy supply and the second energy supply are connected a DC bus, a first supply characteristic is measured at the first energy supply, a second supply characteristic is measured at the first energy supply, the controller is configured to manage power transfer from the first energy supply to the second energy supply based on the first supply characteristic, the second supply characteristic, or both.

In some examples, the first energy supply can include a first energy storage bank and a first generator, and the second energy supply comprises a second energy storage bank and a second generator. In some examples, the first generator and second generator are wind turbines, fuel-based generators, solar photovoltaic cells, concentrating solar generators, or hydroelectric turbines. In some examples, the first supply characteristic and the second supply characteristic are energy storage levels, power generation rates, or power usage rates. In some examples, the first charging station and the second charging station are configured to charge electric vehicles, equipment, or machinery. In some examples, the controller is a first controller, further including a second controller in electrical communication with the first energy supply and the first charging station, and a third controller in electrical communication with the second energy supply and the second charging station. In some examples, the first energy supply, the first charging station, and the second controller comprise a power station. In some examples, any number of power stations can be connected using DC buses to create a power grid.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 shows an example of a power station.

FIG. 2 shows an example of a system of power stations.

FIG. 3 shows an example of a system of power stations including a system controller.

FIG. 4 shows an example of a method flow for transferring power.

FIG. 5 shows an example of a computer system.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The present disclosure relates to DC power grids and more specifically to modular DC power stations and DC power grids formed by linking multiple power stations. In some examples, a DC power station can include an energy supply (e.g., an energy storage system, a generator, or other source) and a set of loads, such as a data center or charging station, connected to each other via at least one DC bus. A charging station can be configured to supply power to a device such as an electric vehicle, and a data center (e.g., a compute hub, high-performance computing facility, supercomputer facility, cluster computing site, accelerated data center, graphics processing unit (GPU) farm, “AI factories,” etc.) can be configured to consume the power for intensive computing tasks. A high-performance computing facility can include racks of computing devices that draw high levels electrical power, such as 40 kilowatts to 100 kW (or more) of power per active rack, and high voltage DC systems (e.g., about 800 volts or more) can be used to more effectively provide their high power requirements. A controller can monitor the power generated by the generator and the energy level in the energy storage bank and can execute logic sequences to control the generation and usage of power within the station. In some examples, the controller can also be in electrical communication with another controller at another DC power station.

The controller can act as a coordinator between all interconnected devices such as subsequent downstream controllers and devices on the DC grid. The controller can manage and monitor the overall health of the grid and can maintain stability of the grid by directing sources and loads to operate at the same level and in the proper (e.g., same) direction. To do so, the controller can monitor characteristics such as power load, power production, and energy level of various connected resources and can set appropriate resources to absorb power and energy (e.g., receive charge or consume energy) or release power and energy (e.g., discharge or supply energy) on the grid system.

Any number of DC power stations can be connected to one another using DC buses, and any number of DC power station controllers can be in electrical communication with one another. The DC power stations can transfer power between each other using DC buses and DC grid components, and their respective controllers can communicate to determine where power is sent or received. In some embodiments, a grid-level controller can be used that is in electrical communication with multiple (e.g., all) other DC power station controllers and that can determine how power is transferred between sites or stations.

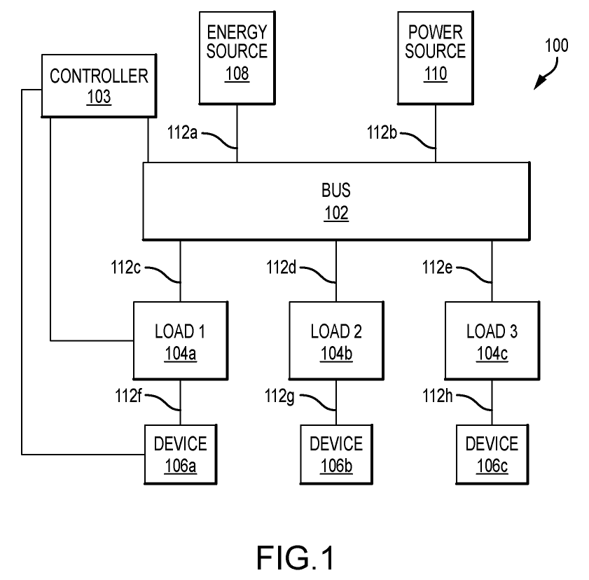

These and other embodiments are further discussed below with reference to FIGS. 1-5. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

As used herein, conjunctive terms (e.g., "and") and disjunctive terms (e.g., "or") should be read as being interchangeable (e.g., "and/or") whenever possible. Furthermore, in claims reciting a selection from a list of elements following the phrase "at least one of," usage of "and" (e.g., "at least one of A and B") requires at least one of each of the listed elements (i.e., at least one of A and at least one of B), and usage of "or" (e.g., "at least one of A or B") requires at least one of any individual listed element (i.e., at least one of A or at least one of B).

FIG. 1 shows an example of a DC power station 100. The DC power station 100 can include a DC bus 102 connected to at least one energy source 108 and/or at least one power source 110. A set of direct connection apparatuses 112a, 112b can facilitate electrical connection and power provision between the DC bus 102 and connected sources 108 and 110. The DC bus 102 can be connected to a set of loads 104a-c via a set of direct connection apparatuses 112c-e, and the set of loads 104a-c can be configured to provide power to, or receive power from, devices 106a-c using a set of direct device connection apparatuses 112f-h.

In some examples, the at least one energy source 108 can comprise one or more sources of DC potential energy, such as at least one mechanical energy storage device (e.g., pumped hydroelectric storage, flywheels, compressed air energy storage (CAES), gravity energy storage, similar devices, and combinations thereof) and/or at least one electrochemical energy storage device (e.g., a bank of batteries or capacitors), along with appropriate conversion devices (e.g., DC-to-DC converters) and control devices (e.g., sensors, computing devices, and other controllers). The at least one power source 110 can be configured to generate DC electrical power for the station 100 using DC electrical power generators such as, for example, wind turbines, hydroelectric turbines, natural gas turbines, solar photovoltaic (PV) cells, concentrating solar generators, nuclear power plants, fuel-based (e.g., gasoline-, hydrogen-, or diesel-fueled) generators, other generators, and combinations thereof. The at least one power source 110 can also include associated conversion and control devices. Additionally, the energy source 108 and power source 110 can include a housing (e.g., a cabinet or container) for storage, protection, or aesthetic reasons. Thus, the sources 108, 110 can be held at the station 100 near the other components of the system in order to facilitate minimization of transfer losses and to enable a station 100 to be set up in remote locations and without needing large utility-scale production or storage facilities. For example, the sources 108, 110 can be sized (physically and electrically) and configured to provide power to a predetermined, relatively small set of loads 104a-c rather than to an indeterminately large number of other locations and loads. Although three loads 104 are shown in FIG. 1, any number of loads may be implemented at a station. Generally, for a station providing EV charging, the number of loads can range from about two to about one hundred charging stations, along with other typical loads such as lighting, climate control apparatuses, computers, etc. For a station supplying a data center, the number of loads can be numerous, such as computer servers numbered in the thousands, tens of thousands, or more. The sources 108, 110 can be configured to connect to the DC bus 102 through an integrated energy management system (EMS). The central bus 102 can serve as the primary conduit for aggregating power from multiple sources 108, 110, ensuring stable and reliable energy delivery to the loads (e.g., charging and/or computing power infrastructure). Each source may be electrically interfaced with the bus 102 via power conditioning units (PCUs), cables, conduits, and other kinds of connections that are part of the direct connection apparatuses 112. These PCUs may be equipped with converters tailored to adapt the specific output characteristics of each source to the standardized voltage and frequency of the DC bus 102.

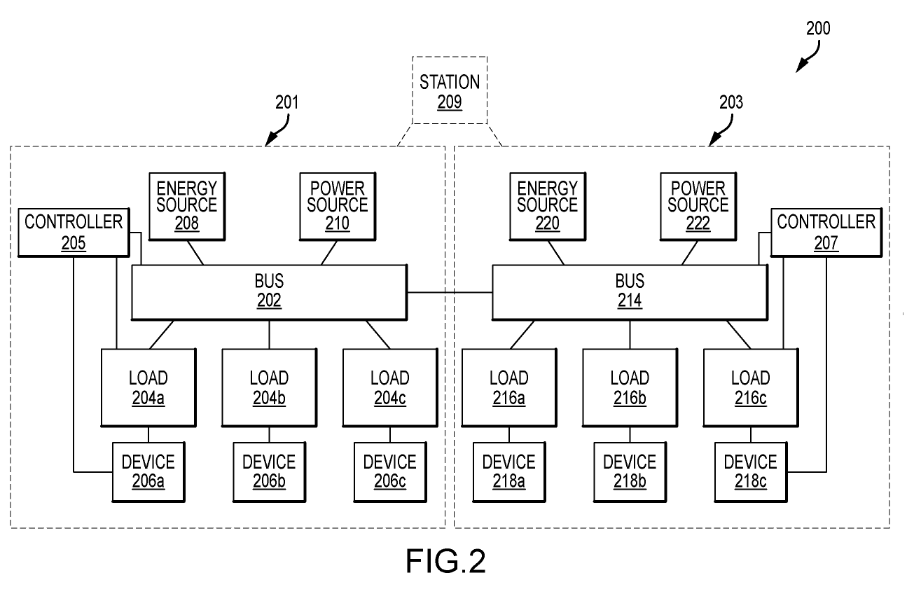

In some examples, the system may include monitoring and control circuitry to dynamically manage power flow from each source based on load demand and/or demand from other interconnected stations or sites, as further discussed in connection with FIG. 2, and in view of source availability. In one illustrative example, a controller 103 can communicate with the EMS to prioritize renewable energy sources while integrating backup or supplementary power from non-renewable generators during peak loads or renewable energy downtime. Bidirectional power converters may also be employed to support energy storage devices such as batteries or capacitors, allowing surplus energy to be stored and discharged by the energy sources 108, as needed.

The bus 102 may be configured with protection mechanisms, including overcurrent relays, isolation switches, and circuit breakers, to safeguard the station against faults or surges. Additionally, an optional interface can enable the bus 102 to exchange power with other stations in a DC grid, such as by exporting excess generation or importing supplemental power when on-site generation or sources are insufficient to serve the loads. Various embodiments can therefore enable a modular, scalable, and adaptable system that optimizes energy utilization while maintaining the reliability required for load operations (e.g., EV charging and data center computing operations).

Moreover, in some examples, the DC power station 100 can include a controller 103 in electrical communication with individual PCUs of the sources 108, 110, the DC bus 102, the loads 104a-c (e.g., charging stations or computer server racks), and/or devices 106a-c (e.g., vehicles or computing devices). In some examples, the controller 103 can determine when to supply or generate power from the sources 108, 110 and when and how to distribute it to the devices 106a-c. In some examples, an energy supply characteristic (e.g., a charge level of a battery or other rechargeable energy storage device, voltage, current, etc.) can be sensed at the at least one energy source 108 by the controller 103. A generator characteristic (e.g., a level of power generation, voltage, current, etc.) can be sensed at the at least one power source 110. In some examples, a device characteristic (i.e., device charge level) can be sensed or communicated at the loads 104a-c. The controller 103 can use any of these characteristics to determine how power is generated, stored, or discharged. In some examples, the devices 106a-c can supply power to the DC power station 100, which can also be governed by the controller 103. Thus, the controller 103 can automate the power management of the DC power station 100.

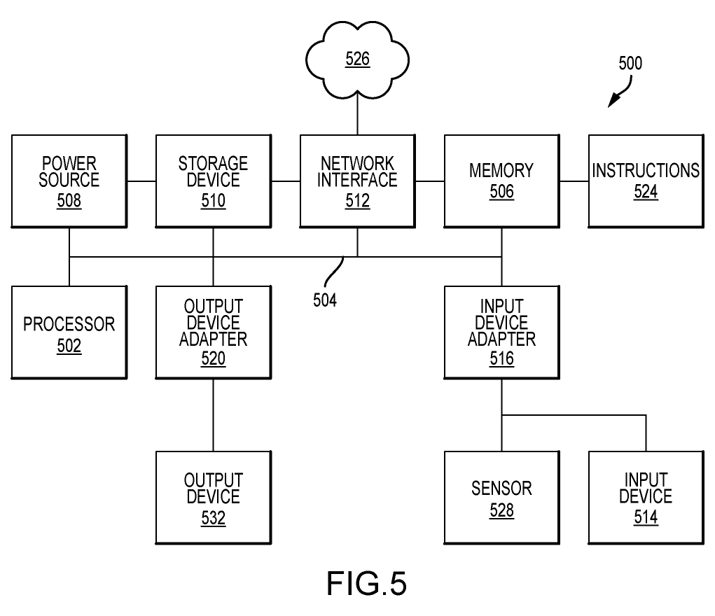

As used herein, parts in "electrical communication" with each other are configured to exchange electrical signals, directly or indirectly, between each other, whether unidirectionally or bidirectionally. A generator (e.g., a power source 110) can be said to be in electrical communication with a processor or controller device if the processor or controller device is using signals generated by the generator or if the processor or controller device is using signals reliant upon or derived at least in part on the signals generated by the generator. For example, the generator can be in electrical communication with a processor via an input device adapter (i.e., a sensor or similar component) and an electrical communications bus, as indicated in FIG. 5 and described in further detail below.

In some examples, the DC power station 100 can have its component parts small enough to install on a single plot of land and be configured to power a building, machinery, electric vehicles, or other energy needs. In some examples, generating power locally can decrease dependency on utility or municipal grid systems, enabling greater energy security, cheaper power, and easily maintainable infrastructure. On-site DC power stations can also be easily upgraded compared to utility power grids, may allow for fewer centralized outages during large outage events like those caused by natural disasters, and may help electrify rural or remote communities.

Any of the features, components, and/or parts, including the arrangements and configurations thereof shown in FIG. 1, can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

FIG. 2 shows a schematic view of a DC power grid 200 according to an embodiment of the present disclosure. The DC power grid 200 can include a first DC power station 201 connected to a second DC power station 203 and a third DC power station 209 via interconnected DC buses 202, 214. In some examples, the DC power station 201 can include a bus 202 connected to energy and power sources 208, 210 using DC connection apparatuses (e.g., similar to 112a, 112b). The bus 202 can be connected to loads 204a-c using DC connection apparatuses (e.g., similar to 112c-e). The loads 204a-c (e.g., EV charging stations or racks of computing devices) may be connected or connectable to one or more consumption devices 206a-c (e.g., electric vehicles or individual computing devices). In some examples, energy and power sources 208, 210 can be configured to generate or store DC power. In some examples, DC power station 201 can further include a controller 205 in electrical communication with at least the bus 202, load 204a, and device 206a. Like controller 103 described above in reference to FIG. 1, controller 205 can determine or calculate a variety of sensed characteristics to determine how energy is generated, stored, or delivered.

In some examples, the second DC power station 203 can include a bus 214, energy and power sources 220, 222, loads 216a-c, and/or devices 218a-c corresponding in nature to the features of the same name in station 201. DC power station 203 can also include a controller 207, which can function substantially similarly to controller 205 for station 203.

Yet another DC power station 209 can also include similar components to DC power stations 201 and 203 and is schematically shown connected to the stations 201. Station 209 can therefore have its own DC bus connected to the other buses 202, 214 of stations 201 and 203. The stations 201, 203 can be directly linked to each other using transmission lines and may thereby share the same bus voltage and may be controlled to provide power to each other as if operating using a single unified bus.

Thus, as shown in FIG. 2, DC power stations 201, 203, and 209 can be connected to one another. In some examples, DC power stations 201, 203, and 209 can be in electrical communication with one another. DC power stations 201, 203, and 209 can also be connected using DC buses and can transfer power between the stations 201, 203, and 209. In some examples, the respective controllers of DC power stations 201, 203, and 209 can communicate with one another to determine when, how much, where to, and where from power is transferred. In this manner, a DC power grid can be made with modular DC power stations like stations 201, 203, and 209. Additionally, the number of stations that can be connected this way is not limited to two or three. Any number of stations can be interconnected to form a DC power grid capable of supplying or receiving power between sites, stations, and locations. In some examples, different customers or users can be associated with one or more of the connected stations 201, 203, 209, and each customer may be capable of controlling their respective station to supply or receive power from other sites via the grid-forming connections between different stations 201, 203, 209. In some examples, the respective controllers (e.g., 205, 207, etc.) of the DC power stations 201, 203, and 209 can transfer power to and from one another while accounting for the monetary value of the power provided and charge different owners, users, or customers based on the power they receive, the power they generate, and the power they transfer to other stations.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2.

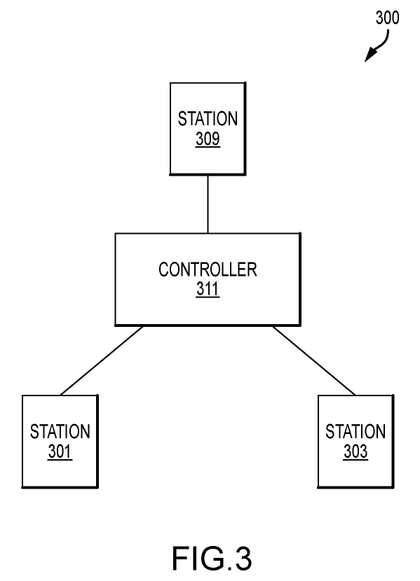

FIG. 3 shows a schematic view of a DC power grid 300 including DC power stations 301, 303, and 309 connected to each other using grid-forming connections that unite DC buses. DC power stations 301, 303, and 309 can be substantially similar to the DC power stations 201, 203, and 209 described above in reference to FIG. 2 or station 100 in FIG. 1. DC power grid 300 can also include a grid-level controller 311 that is enabled for electrical communication with the respective station-level controllers (e.g., 103, 205, and/or 207) of the various DC power stations 301, 303, and 309. In some examples, the grid-level controller 311 can receive various characteristics and information from station-level controllers and execute logic sequences to determine when, how much, where to, and where from power is transferred between the DC power stations 301, 303, and 309. A grid-level controller 311 can decrease the complexity of multiple controllers communicating with one another and simplify and accelerate the power transfer process. Any number of stations can be connected to each other and to the grid-level controller 311 to enable a DC grid with management and oversight of all stations by the controller 311. In some embodiments, at least one station is not enabled by a user or customer to send or export power from its sources to other stations but is enabled to import or receive power from other stations. The grid-level controller 311 can therefore track consumption by that station and can control other stations to provide power to that station as needed. Likewise, stations may be enabled only to export power and not to import power, and the grid-level controller 311 can track their provision of power and can control other stations to use power from that station as needed. Accordingly, the grid-level controller 311 can balance supply and demand of power across the DC power grid 300.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

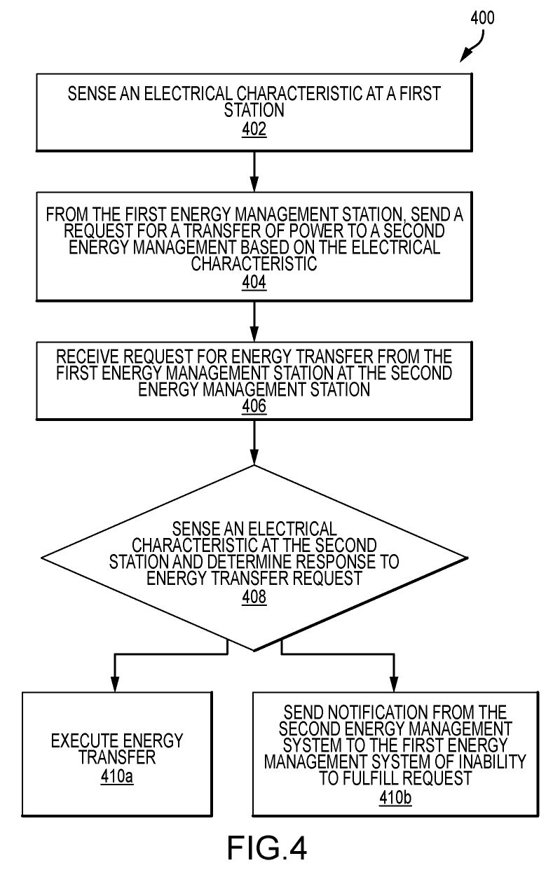

FIG. 4 shows a diagram illustrating a method 400 of determining power transfer between DC power stations such as the stations described in connection with FIGS. 1-3. The method may be implemented by a computing device (e.g., controller 103, 205, 207, and/or 311) described elsewhere herein. The computing device may be configured to communicate with and control components of one or more DC power stations (e.g., 301, 303, 309) in a DC grid (e.g., 300).

First, as shown in block 402, the method 400 may include sensing an electrical characteristic at a first DC power station. In some examples, the electrical characteristic may be a power level of an energy storage device at a station (or for the DC grid as a whole), a rate of power generation of a station or site (or for the DC grid as a whole), a state of charge of one or more devices on the DC grid (e.g., a source battery or connected load/EV battery), or available power from a device or set of devices connected to the DC power grid.

In block 404, a first DC power station of the grid can be directed by the controller to send electrical energy or power to a second DC power station based on the energy characteristic of block 402. In some examples, a grid controller 311 can directly control sources at one station (e.g., 201) to discharge energy or generate power to a bus (e.g., 202) and to make the discharged energy or generated power available to a second station (e.g., 203) via the connection to its respective bus (e.g., 214). Thus, the DC grid can have a central management system in the grid controller.

In some examples, the grid level controller 311 can be in communication with a local station controller (e.g., 205) and can provide electronic instructions, requests, or similar signals to the local station controller to control its station’s energy sources (e.g., 208) and/or power sources (e.g., 210) to provide supply or to control its station’s loads and/or devices (e.g., 204a-c and/or 206a-c) to consume energy. Thus, the DC grid may have a hierarchical organization and administration of directions and instructions to implement changes to the available power and power consumption across the DC grid via the linked buses in the grid (e.g., 202 and 214).

In block 406, a second DC power station receives the energy transfer request from the first DC power station.

In block 408, a controller (e.g., the grid level controller 311 or a local controller at the second DC power station) may sense an electrical characteristic of the second DC power station and may determine whether or not to transfer the power requested. In some examples, power can be transferred from the first DC power station to the second DC power station. In other words, the first DC power station can “backfeed” to the DC grid to which it is connected, thereby providing power to one or more other DC power stations. This capability can be especially beneficial in situations where power could otherwise be cut off to the first station or during an outage of a central power plant, since the interconnected DC power stations can act as redundant power providers as needed. The available energy/power resources can then be used by loads and devices (e.g., 216a-c and/or 218a-c) at the second station. In other examples, power can be transferred from the second DC power station to the first DC power station. These outcomes are shown in block 410a. In yet other examples, an energy transfer cannot be completed (i.e., due to low available power or energy supply levels in either the first DC power station or the second DC power station or incapability of a station to consume power from its DC bus), and a notification is sent from the second DC power station to the first DC power station, as shown in block 410b.

Logical instructions like those shown in FIG. 4 can be used to calculate power transfers between DC power stations and can be executed by station-level controllers or grid-level controllers. In some examples, users can change the parameters of power transfer via computers and input devices described below in reference to FIG. 5.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

FIG. 5 shows a high-level block diagram of a computer system 500 that can be used to implement embodiments of the present disclosure. In various embodiments, the computer system 500 can comprise various sets and subsets of the components shown in FIG. 5. Thus, FIG. 5 shows a variety of components that can be included in various combinations and subsets based on the operations and functions performed by the system 500 in different embodiments. For example, the computer system 500 can be part of the controllers 103, 205, 207, and/or 311 described above in connection with FIGS. 1, 2, and 3. It is noted that, when described or recited herein, the use of the articles such as “a” or “an” is not considered to be limiting to only one, but instead is intended to mean one or more unless otherwise specifically noted herein.

The computer system 500 can comprise a central processing unit (CPU) or processor 502 connected via a bus 504 for electrical communication to a memory device 506, a power source 508, an electronic storage device 510, a network interface 512, an input device adapter 516, and an output device adapter 520. For example, one or more of these components can be connected to each other via a substrate (e.g., a printed circuit board or other substrate) supporting the bus 504 and other electrical connectors providing electrical communication between the components. The bus 504 can comprise a communication mechanism for communicating information between parts of the system 500.

The processor 502 can be a microprocessor or similar device configured to receive and execute a set of instructions 524 stored by the memory 506. The memory 506 can be referred to as main memory, such as random access memory (RAM) or another dynamic electronic storage device for storing information and instructions to be executed by the processor 502. The memory 506 can also be used for storing temporary variables or other intermediate information during execution of instructions executed by the processor 502. The processor 502 can include one or more processors or controllers, such as, for example, a CPU for the computing device 500 in general and an input device 514 or a sensor 528. The power source 508 can comprise a power supply capable of providing power to the processor 502 and other components connected to the bus 504, such as a connection to an electrical utility grid (e.g., the DC grid 300) or other source (e.g., an energy source 108 or power source 110).

The storage device 510 can comprise read-only memory (ROM) or another type of static storage device coupled to the bus 504 for storing static or long-term (i.e., non-dynamic) information and instructions for the processor 502. For example, the storage device 510 can comprise a magnetic or optical disk (e.g., hard disk drive (HDD)), solid state memory (e.g., a solid state disk (SSD)), or a comparable device.

The instructions 524 can comprise information for executing processes and methods using components of the system 500. Such processes and methods can include, for example, the methods described in connection with other embodiments elsewhere herein, including, for example, the methods and processes described in connection with FIG. 4.

The network interface 512 can comprise an adapter for connecting the system 500 to an external device via a wired or wireless connection. For example, the network interface 512 can provide a connection to a computer network 526 such as a cellular network, the Internet, a local area network (LAN), a separate device capable of wireless communication with the network interface 512, other external devices or network locations, and combinations thereof. In one example embodiment, the network interface 512 is a wireless networking adapter configured to connect via WI-FI(R), BLUETOOTH(R), BLE, Bluetooth mesh, or a related wireless communications protocol to another device having interface capability using the same protocol. In some embodiments, a network device or set of network devices in the network 526 can be considered part of the system 500. In some cases, a network device can be considered connected to, but not a part of, the system 500. The network connection can enable a controller (e.g., grid level controller 311) to communicate with other controllers in the DC grid for various stations or for individual controllers of devices, sources, or loads.

The input device adapter 516 can be configured to provide the system 500 with connectivity to various input devices 514. In an example embodiment, the input device adapter 516 can be connected to a keyboard, a screen, another input device 514, or a sensor 528 to adapt a user input or sensor input to readable instructions 524 stored in the memory 506.

The sensors 528 can be used to detect power level of an energy storage device, a rate of power generation, bus or device voltage, current, or other electrical properties, or available charge from a device and to convert those phenomena to electrical signals. The input device 514 or another input device can be used to provide user input such as input regarding the settings of the system 500. In some embodiments, the input device adapter 516 can be connected to the input device 514 or sensor 528, whether by a wired connection or by a wireless connection.

The output device adapter 520 can be configured to provide the system 500 with the ability to output signals and other information, such as energy usage information, power transfer logs, time-period based billing amounts, and more. The output device adapter 520 can therefore be connected to at least one output device 532 (e.g., a display, printer, antenna, or other device for providing information to other devices). Other output devices, or combinations thereof, can also be used. The processor 502 can be configured to control the output device adapter 520 to provide information to a user via the output devices connected to the adapter 520.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A DC grid system, comprising:
a DC energy or power source connected to a first station using a first DC bus;
a DC energy or power load connected to a second station using a second DC bus; and
a controller;
wherein:
the controller is in electrical communication with the first station and the second station;
the DC energy or power source and the DC second energy or power load are connected via an electrical connection between the first DC bus and the second DC bus;
a first electrical characteristic is measured at the DC energy or power source;
a second electrical characteristic is measured at the DC energy or power load;
the controller is configured to control power transfer from the first station to the second station based on the first electrical characteristic, the second electrical characteristic, or both.

2. The DC grid system of claim 1, wherein:
the DC energy or power source comprises a battery or a generator; and
the DC energy or power load comprises a charging station.

3. The DC grid system of claim 2, wherein the DC energy or power source outputs a DC voltage.

4. The DC grid system of claim 1, wherein the first electrical characteristic and the second electrical characteristic include at least one of: an energy storage level, a power generation rate, or an electrical consumption rate.

5. The DC grid system of claim 1, wherein the DC energy or power load is configured as a charging station to charge electric vehicles, equipment, or machinery.

6. The DC grid system of claim 1, wherein the controller is a first controller, wherein the system further comprises:
a second controller in electrical communication with the first station; and
a third controller in electrical communication with the second station.

7. The DC grid system of claim 6, wherein the second controller is configured to control components at the second station in response to at least one signal from the first controller.

8. The DC grid system of claim 1, wherein a plurality of stations is connected via DC buses to create a DC power grid.

9. The DC grid system of claim 1, wherein only DC energy or power sources are connected to the first station.

10. The DC grid system of claim 1, wherein only DC energy or power loads are connected to the second station.

11. The DC grid system of claim 1, wherein the DC energy or power load is configured as a data center, supercomputer, or cluster computing facility.

12. A DC grid station, comprising:
a controller;
at least one DC source, the at least one source including at least one energy source or at least one power source;
a set of DC loads;
a DC bus connecting the at least one source to the set of DC loads;
wherein the controller is configured to detect power provided by the at least one source to the bus and consumption of the set of DC loads from the bus;
wherein, when the power provided by the source to the bus exceeds the consumption of the set of DC loads from the bus, the controller is enabled to execute energy transfer to a second DC grid station via the bus.

13. The DC grid station of claim 12, wherein the controller is enabled to execute energy transfer to a second bus of the second DC grid station, wherein the bus of the DC grid station is in electrical communication with the second bus of the second DC grid station.

14. The DC grid station of claim 12, wherein the set of DC loads includes a plurality of computer server racks.

15. The DC grid station of claim 12, wherein the controller is in electronic communication with a second controller of the second DC grid station, and wherein the controller receives a signal indicating an electrical characteristic of the second DC grid station.

16. A computer-implemented method for controlling distribution of direct-current (DC) power between DC power stations, the method comprising:
receiving, at a controller of a first station, an energy transfer request originating from a second station;
sensing, by the controller, at least one electrical characteristic of the first station;
determining, by the controller, whether to accept the energy transfer request based on the at least one electrical characteristic;
wherein, when the controller accepts the energy transfer, components of the second station are controlled to transfer electrical power via an electrical connection between a first DC bus of the first station and a second DC bus of the second station; and
wherein, when the controller does not accept the energy transfer, the controller transmits a signal declining the energy transfer.

17. The computer-implemented method of claim 16, wherein the at least one electrical characteristic comprises an available power value for the first station.

18. The computer-implemented method of claim 17, wherein determining, by the controller, whether to accept the energy transfer request comprises determining whether the available power indicates excess power at the first station.

19. The computer-implemented method of claim 16, wherein the components of the second station are controlled to transfer electrical power from the first station to the second station.

20. The computer-implemented method of claim 16, wherein the components of the second station are controlled to transfer electrical power from the second station to the first station.
